(19) United States
(12) Patent Application Publication
(10) Pub. No.: US 2004/0128646 A1
(43) Pub. Date: Jul. 1, 2004

(54) System and method of product development

(76) Inventors: Dinesh K. Jindal, Naperville, IL (US); William S. Brown II, Aurora, IL (US)

Correspondence Address: FAY, SHARPE, FAGAN,, MINNICH & McKEE, LLP, Seventh Floor, 1100 Superior Avenue, Cleveland, OH, 44114-2579, US

(21) Appl. No.: 10/335,531

(22) Filed: Dec. 31, 2002

(51) Int. Cl. G06F 9/44

(52) U.S. Cl. 717/102; 717/122; 717/120

(57) ABSTRACT

A system for consolidating project development data from a plurality of project development work groups. The invention includes a plurality of data sources providing project development data in native formats from the project development work groups. At least some of the native formats are dissimilar enough to prevent direct data sharing between at least some of the data sources. The system also includes a data bus connected to the data sources for transferring data in a universal format and a plurality of interfaces connected to the data bus and the data sources for converting data from the data sources native formats into the universal format. A data pool connected to a data bus serves as a reference for the entire enterprise data where all the providers and consumers of the data are connected to the data bus. A data manager connected to the data pool provides all the administrative functions for the data pool.

### BACKGROUND OF THE INVENTION

The present invention relates to a system and method for product development, and more particularly to a system and method for product development which provides integration and synchronization of existing data producing systems.

In the business environment, product development which results in the production of a product can involve a complex interaction of different personnel, each providing specialized functions which eventually come together to form the finished product. The different specialized personnel typically operate independently, yet most are tied together in a dependent relationship in which they may utilize information from others. Also, they may be tied together due to scheduling constraints.

Each of these different personnel may use different systems in the course of their work. As a result, product development projects may utilize a variety of data from many different existing systems including different software systems and databases.

Many times, these systems can be so dissimilar as to be non-compatible. For example, different software applications may not be able to communicate directly with each other. As a result, portions of the different data generated by these different systems must be regenerated reducing the efficiency of the operation. Also, non-compatibility can lead to the duplication of services which, can also reduce the efficiency of the product development project and lengthen the development time table.

It is desirable to provide a data-driven product development platform giving a single, consistent view of the data provided by different, sometimes incompatible, sources associated with a project for improved integration and synchronization.

### SUMMARY OF THE INVENTION

According to the present invention, a system for consolidating project development data from a plurality of project development work groups is provided. The invention includes a plurality of data sources providing project development data in native formats from the project development work groups. At least some of the native formats are dissimilar enough to prevent direct data sharing between at least some of the data sources. The system also includes a data bus connected to the data sources for transferring data in a universal format and a plurality of interfaces connected to the data bus and the data sources for converting data from the data sources native formats into the universal format. A data pool connected to a data bus serves as a reference for the entire enterprise data where all the providers and consumers (applications) of the data are connected to the data bus. The interfaces provide the conversion necessary to enable the applications to be compatible with the data pool so that the existing applications do not need to be upgraded. A data manager connected to the data pool (directly or via the data bus) provides all the administrative functions for the data pool.

A method for consolidating project development data from a plurality of project development work groups is also provided. The method includes providing project development data from a plurality of project development work groups in native formats. At least some of the native formats are dissimilar enough to prevent direct data sharing between work groups. The method also includes converting the project development data in the native formats to a universal format, transferring the project development data to a common data pool, and providing user selectable project development data from the data pool to an end user.

The advantages and benefits of the present invention will become apparent to those of ordinary skill in the art upon reading and understanding the following detailed description of the preferred embodiments.

### BRIEF DESCRIPTION OF THE DRAWINGS

The drawings are only for purposes of illustrating preferred embodiments and are not to be construed as limiting the invention. The invention may take form in various components and arrangements of components, and in various steps and arrangements of steps, preferred embodiments of which will be illustrated in the accompanying drawings wherein:

FIG. 1 is block diagram illustrating the system of product development in accordance with the invention; and

FIG. 2 illustrates the method of product development in accordance with the invention.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

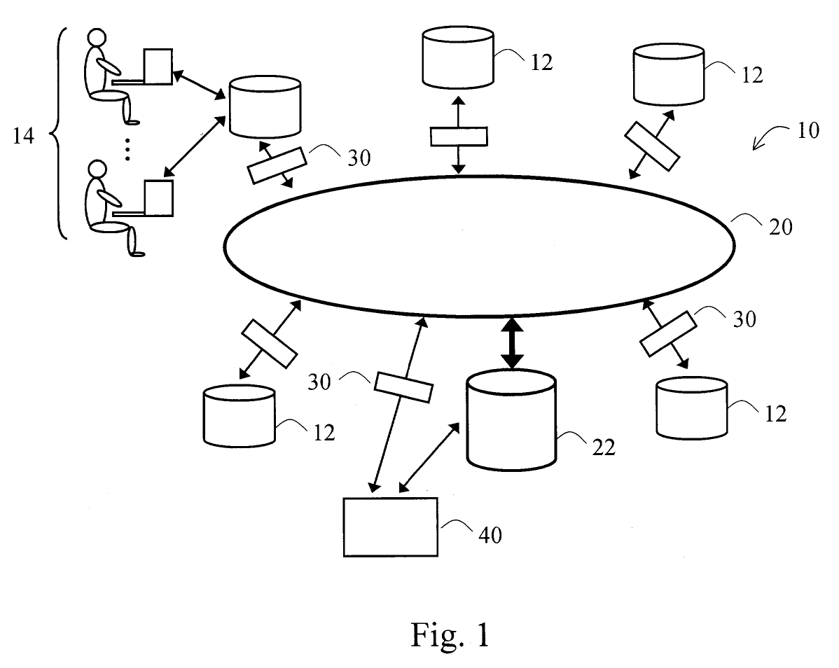

Referring to FIG. 1 a block diagram of a project development application is shown generally at 10. The application includes a plurality of data sources 12 providing project development data.

Examples of the data source 12 can include, but are not limited to databases, tables, arrays, or any other suitable known data source. A work group 14 (only one of which is shown for simplicity) consisting of one or more persons working on the project can generate the product development data which is communicated to the data source 12.

Examples of the data can include, but are not limited to: software development data produced by a software developer, a hardware development data produced by a hardware developer, system delivery data produced by an installer, product manufacturing tool information produced by factory personnel, software deployment information produced by a software deployer, product testing information produced by product testing personnel, hardware delivery information produced by a hardware developer, third party development information produced by a third party and product offering information produced by a product manager.

For each data source, the format of the data, called the native format, is derived by the particular software tool used by the workgroup. In accordance with the invention, different work groups 14 can generate project development data using different software tools. At least some of the native formats are dissimilar enough to prevent direct data sharing between at least some of the data sources. Examples of some of these formats include, but are not limited to, product data stored in a UNIX based flat data source used by lab support, problem log storing information via ORACLE data source used by testers and/or developers, product development progress stored in Microsoft Project or Excel applications used by project managers and developers, as well as some graphical and pictorial details including some physical drawings.

The application 10 also includes a data bus 20 connected to the data sources 12 for transferring data in a universal format to a data pool 22. The data bus 20 can be any suitable known data bus for transferring data including, but not limited to, Microsoft Access based data objects which allows ease of expansion, conversion with linking/importing to/from many other forms such as text, spreadsheets, etc. as well as data reformatting.

The application also includes a plurality of interfaces 30 connected to the data bus 20. An interface 30 is typically connected to each data source 12 for converting data from the data source native format into the universal format. Alternatively, one or more data sources 12 may use the same interface.

The interface 30 can convert the data source data by linking the data source data to the data pool 22 in a known manner. Linking retains only a single copy of the data with a reference to the data in the data-bus, so that all changes to the native data are available to the work group applications 14 in real time. Accordingly, linking allows dynamic updating of the data pool 22 when the data source data is changed.

Alternatively, the interface 30 can convert the data source data by importing the data source data to the data pool 22 in a known manner. Importing provides updates to the data pool 22 of changed data source data at the time the changed data is imported. The data source data that is changed replaces the corresponding data of universal format in the data pool 22.

A data manager 40 is connected to the data pool 22 for providing user selectable project development data from the data pool 22 in a universal format to one or more users (not shown). The data manager 40 can be any suitable application, such as Microsoft Access, which can enable the user to query the data pool 22 and/or data sources 12 and retrieve any user selectable information. The data manager 40 is connected directly to the data pool 22. The data manager 40 can also be connected to the data sources 20 via its own interface layer 30 in a similar manner as the work group applications 14. Connecting the data manager 40 to the data pool 22 provides a consistent access method and provides security to the data pool. That is, all the access and security logic is embedded in the data bus 20 and no other application has direct control over the data pool 22.

The user(s) can be anyone with appropriate permissions. Different levels of user permissions can be set up in a known manner to allow different amounts of accessibility to the information in a known manner.

The product development project can include several tasks that must be completed before the project completed. One or more of these tasks can be constraint-based tasks, which can include several constraints that must be met, or provided for, before the task can be completed. These constraints can be interdependent, depending upon data provided by, or tasks that must be completed by, one or more other work groups.

For example, in the development of an electronic device, a digital display may be required. The digital display will have design constraints which can include the type of display, such as LCD, plasma, LED, etc. The task for choosing and/or designing the digital display that will be used in the electronic device is constraint-based, including such constraints as power requirements and size requirements, among others. Therefore, before the task of choosing and/or designing the display can be completed, the constraints must be available and provided to the workgroup responsible for performing this task. A person within the display workgroup, operating as a user, can use the data manager 40 to query the data pool to obtain all the necessary constraints to complete the task.

The product development project can include several task completion dates. One or more of these task completion dates can be interdependent task completion dates, which depend upon the completion of other tasks. Therefore, these interdependent task completion dates will fall after the task completion dates on which they depend.

For example, using the example above, the task completion date for determining at least some of the constraints for the display will depend upon, and therefore fall after, the task completion date of determining at least some of the constraints of the power supply.

Using known database queries to query the data pool 22 and/or the data sources 12, the data manager 40 can provide a user, such as a person within the display workgroup, a timetable showing the projected completion dates of the tasks upon which the interdependent task completion date depends. The data manager can also include an alarm for notifying the user in advance of the interdependent task completion date. Further, the data manager 40 can provide the user with all the necessary constraints which must be fulfilled to complete this task.

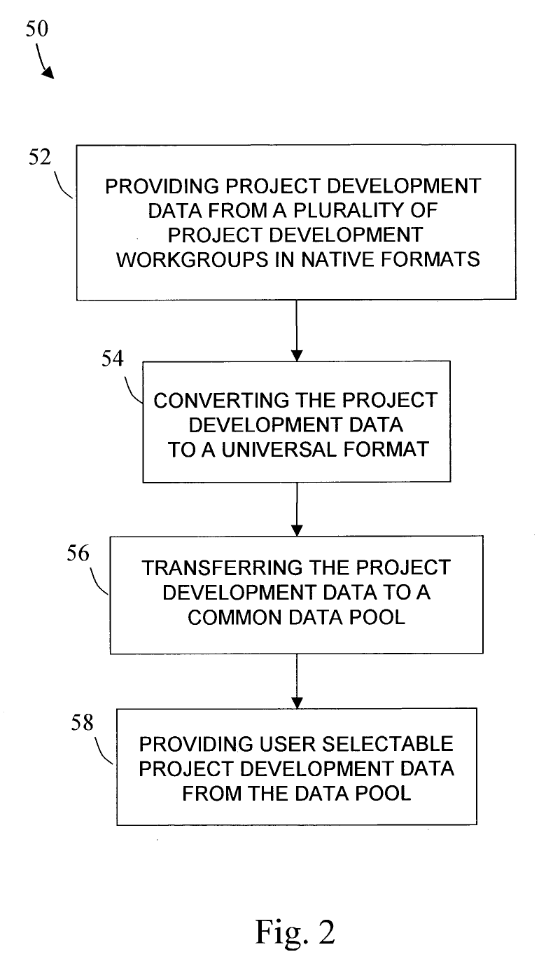

Referring now to FIG. 2, the invention includes a method of project development shown generally at 50 for consolidating project development data from a plurality of project development work groups 14. The method includes providing project development data from a plurality of project development work groups in native formats at 52. At least some of the native formats are dissimilar enough to prevent direct data sharing between work groups.

The method further includes converting the project development data in the native formats to a universal format at 54 and transferring the project development data to a common data pool at 56 The method also includes providing user selectable project development data from the data pool to an end user at 58.

The invention provides a simple mechanism for communicating incremental growth of the project solution throughout the development cycle to all users who require this information. This information can be made available to all users regardless of different native formats used by the data sources. The invention allows the use of different existing data sources, known as legacy systems, which can include commercial and/or custom built applications. The invention centralizes the project solution information providing a simplified and orderly access to the data stored in the data pool.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A project development application for consolidating project development data from a plurality of project development work groups comprising:
a plurality of data sources providing project development data in native formats from the project development work groups, wherein at least some of the native formats are dissimilar enough to prevent direct data sharing between at least some of the data sources;
a data bus connected to the data sources for transferring data in a universal format;
a plurality of interfaces connected to the data bus and the data sources for converting data from the data sources native formats into the universal format;
a data pool connected to the data bus; and
a data manager connected to the data pool for providing user selectable project development data from the data pool in a universal format to an end user.

2. The project development application defined in claim 1 wherein at least one of the interfaces links the data from the data sources to the data pool.

3. The project development application defined in claim 1 wherein at least one of the interfaces imports the data from the data sources to the data pool.

4. The project development application defined in claim 1 wherein at least one of the project development work groups has an interdependent task completion date depending upon the task completion date of another project development work group and the data manager notifies the user of the interdependent task completion date.

5. The project development application defined in claim 4 where the data manager includes an alarm for notifying the user of the interdependent task completion date.

6. The project development application defined in claim 1 wherein at least one of the project development work groups has constraint-dependent tasks depending upon the completion of other tasks and the data manager notifies the user of the constraint-dependent tasks.

7. The project development application defined in claim 1 wherein the data manager notifies the user of the other tasks.

8. A method of project development for consolidating project development data from a plurality of project development work groups comprising:
providing project development data from a plurality of project development work groups in native formats, wherein at least some of the native formats are dissimilar enough to prevent direct data sharing between work groups;
converting the project development data in the native formats to a universal format;
transferring the project development data to a common data pool; and
providing user selectable project development data from the data pool to an end user.

9. The method of project development defined in claim 8 wherein the converting step includes linking the data between data sources and the common data pool.

10. The method of project development defined in claim 8 wherein the converting step includes importing the data between data sources and the common data pool.

11. The method of project development defined in claim 8 wherein at least one of the project development work groups has an interdependent task completion date depending upon the task completion date of another project development work group and further including the data manager notifying the user of the interdependent task completion date.

12. The method of project development defined in claim 8 wherein at least one of the project development work groups has constraint-dependent tasks depending upon the completion of other tasks and the data manager notifies the user of the constraint-dependent tasks.

13. The method of project development defined in claim 12 further including the data manager notifying the user of the other tasks.
